(19) United States
(12) Patent Application Publication
(10) Pub. No.: US 2024/0032644 A1
(43) Pub. Date: Feb. 1, 2024

(54) FOOT SUPPORT STRUCTURE

(71) Applicant: Sangbok CHOI, Ulsan (KR)

(72) Inventor: Sangbok CHOI, Ulsan (KR)

(21) Appl. No.: 18/256,342

(22) PCT Filed: Nov. 1, 2021
(86) PCT No.: PCT/KR2021/015582

§ 371 Date: Jun. 7, 2023

(30) Foreign Application Priority Data
Dec. 8, 2020 (KR) 10-2020-0170570

(51) Int. Cl. A43B 7/1455; A61H 39/04

(52) U.S. Cl. CPC A43B 7/146; A61H 39/04; A61H 2205/125; A61H 2201/1642; A61H 2201/165

(57) ABSTRACT

Proposed is a foot support structure that allows the Yongcheon acupoint of a user to be effectively stimulated while the user is sitting so that the user can breathe identically or similarly to when the user is standing, the foot support structure including a base plate placed under the foot and supporting the foot, a big toe support portion having a plate shape and protruding from the base plate at a position where the big toe is placed, a second and third toe support portion having a plate shape and protruding from the base plate at a position where the second toe and the third toe are placed, a heel support portion having a plate shape and protruding from the base plate at a position where the heel is placed, and a Yongcheon acupoint stimulator protruding from the base plate at a position corresponding to the Yongcheon acupoint.

### TECHNICAL FIELD

The present disclosure relates generally to a foot support structure and, more particularly, to a foot support structure that allows the Yongcheon acupoint of a user to be effectively stimulated while the user is sitting.

### BACKGROUND ART

The foot is a sophisticated and delicate part of the body, composed of numerous bones, joints, ligaments, muscles, and numerous blood vessels. Since the foot is where the body's important acupuncture points and meridians are concentrated, the importance of the health of the foot is high enough to be considered directly related to the health of the whole body.

Yongcheon is an acupoint on the sole of the foot. It means “gushing spring”. It is a point located about one-third of the sole, excluding the toes, in a depression that appears when the toes are flexed. It is a well-known acupoint widely used for various diseases in traditional medicine. When stimulated with acupuncture, moxibustion, or acupressure, it helps to improve the flow of energy and promote health.

In particular, according to a paper published in the Journal of Korean Acupuncture & Moxibustion Society, “Effect of Acupuncture and Moxibustion Treatment at the K 1 on the Blood Pressure and Regional Cerebral Blood Flow”, animals received acupuncture treatment on the Yongcheon acupoint had a marked decrease in blood pressure and an increase in regional cerebral blood flow. This shows that stimulation is transmitted to the brain through the blood vessels abundant in the Yongcheon area and the neural network. Therefore, stimulation of the Yongcheon acupoint can increase the regional cerebral blood flow and facilitate breathing. For this reason, insoles for stimulating the Yongcheon acupoint have been developed and commercialized.

Generally, people breathe shallower in the sitting posture than in the standing posture because the chest area is more compressed when they are sitting on a chair, etc. than when standing. This leads to a decrease in blood flow and causes drowsiness. However, since Yongcheon acupoint stimulation (acupressure) insoles currently on the market are configured to be stimulated while the user is standing, there is a problem in that the Yongcheon acupoint cannot be properly stimulated while the user is sitting.

### DISCLOSURE

### Technical Problem

Accordingly, the present disclosure has been made keeping in mind the above problems occurring in the related art, and an objective of the present disclosure is to provide a foot support structure that allows the Yongcheon acupoint of a user to be effectively stimulated while the user is sitting so that the user can breathe identically or similarly to when the user is standing.

### Technical Solution

In order to accomplish the above objective, the present disclosure provides a foot support structure including: a base plate placed under the foot and supporting the foot; a big toe support portion formed in a plate shape and protruding from the base plate at a position where the big toe is placed; a second and third toe support portion formed in a plate shape and protruding from the base plate at a position where the second toe and the third toe are placed; a heel support portion formed in a plate shape and protruding from the base plate at a position where the heel is placed; and a Yongcheon acupoint stimulator protruding from the base plate at a position corresponding to the Yongcheon acupoint.

Furthermore, the big toe support portion may protrude higher than the second and third toe support portion, and a step may be formed at a boundary between the big toe support portion and the second and third toe support portion.

Furthermore, the Yongcheon acupoint stimulator may be provided higher than the big toe support portion, and the heel support portion may protrude to a maximum height equal to that of the second and third toe support portion.

Furthermore, the Yongcheon acupoint stimulator may be provided on top of a second spring supported by the base plate, and may elastically press the Yongcheon acupoint through the second spring.

Furthermore, the heel support portion may be provided so that a longitudinal center line thereof is distorted by a predetermined angle from an imaginary center line formed along a longitudinal direction of the base plate through a center of the Yongcheon acupoint stimulator.

### Advantageous Effects

According to the present disclosure, when the present disclosure is used while a user is sitting, the big toe is supported by a big toe support portion, the second toe and the third toe are supported by the second and third toe support portion, and the heel is supported by the heel support portion, so that the Yongcheon acupoint is pressed by a Yongcheon acupoint stimulator in a state in which a part of the sole of the foot to which force is applied when the user is standing is supported. Therefore, the Yongcheon acupoint can be effectively stimulated even when the user is sitting, thereby increasing the regional cerebral blood flow and facilitating breathing.

By using the present disclosure even when the user is sitting in an office or a car, it is possible to prevent drowsiness through the increase in the regional cerebral blood flow.

### DESCRIPTION OF DRAWINGS

FIG. 1 is a perspective view illustrating a foot support structure according to an embodiment of the present disclosure.

FIG. 2 is a plan view illustrating the foot support structure according to the embodiment of the present disclosure.

FIG. 3 is a side view illustrating the foot support structure according to the embodiment of the present disclosure.

FIG. 4 is an exemplary view illustrating a state in which a user's foot is seated on the foot support structure according to the embodiment of the present disclosure.

FIG. 5 is a perspective view illustrating a bottom structure of a base plate applied to the foot support structure according to the embodiment of the present disclosure.

FIG. 6 is an exemplary view illustrating an example in which the foot support structure according to the embodiment of the present disclosure is used as a shoe insole.

FIG. 7 is a perspective view illustrating a foot support structure according to another embodiment of the present disclosure.

FIG. 8 is a plan view illustrating the foot support structure according to the other embodiment of the present disclosure.

FIG. 9 is a side view illustrating the foot support structure according to the other embodiment of the present disclosure.

FIG. 10 is a sectional view taken along line a-a of FIG. 8.

FIG. 11 is a sectional view taken along line b-b of FIG. 8.

FIG. 12 is an exemplary view illustrating an operation of a Yongcheon acupoint stimulator applied to the foot support structure according to the other embodiment of the present disclosure.

FIG. 13 is an exemplary view illustrating an example in which the foot support structure according to the other embodiment of the present disclosure is used as a footrest.

### MODE FOR INVENTION

The present disclosure proposes a foot support structure that allows the Yongcheon acupoint of a user to be effectively stimulated while the user is sitting so that the user can breathe identically or similarly to when the user is standing, the foot support structure including: a base plate placed under the foot and supporting the foot; a big toe support portion formed in a plate shape and protruding from the base plate at a position where the big toe is placed; a second and third toe support portion formed in a plate shape and protruding from the base plate at a position where the second toe and the third toe are placed; a heel support portion formed in a plate shape and protruding from the base plate at a position where the heel is placed; and a Yongcheon acupoint stimulator protruding from the base plate at a position corresponding to the Yongcheon acupoint.

The scope of the present disclosure is not limited to embodiments described below, and various modifications can be made by those skilled in the art within the scope of the technical gist of the present disclosure.

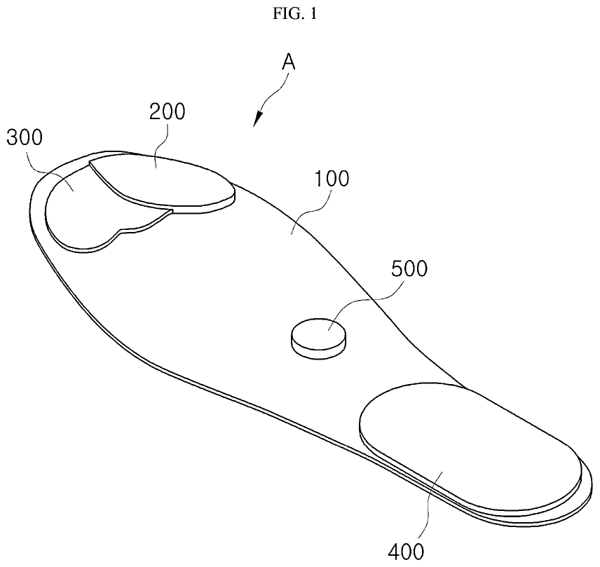

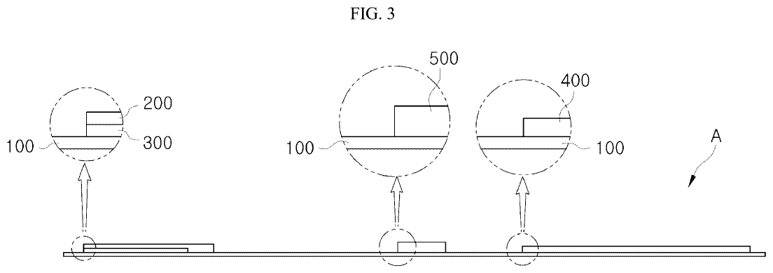

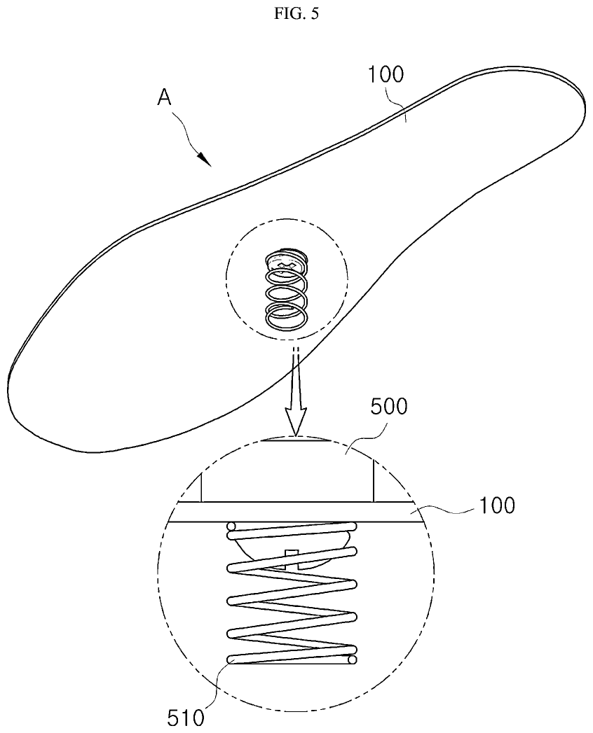

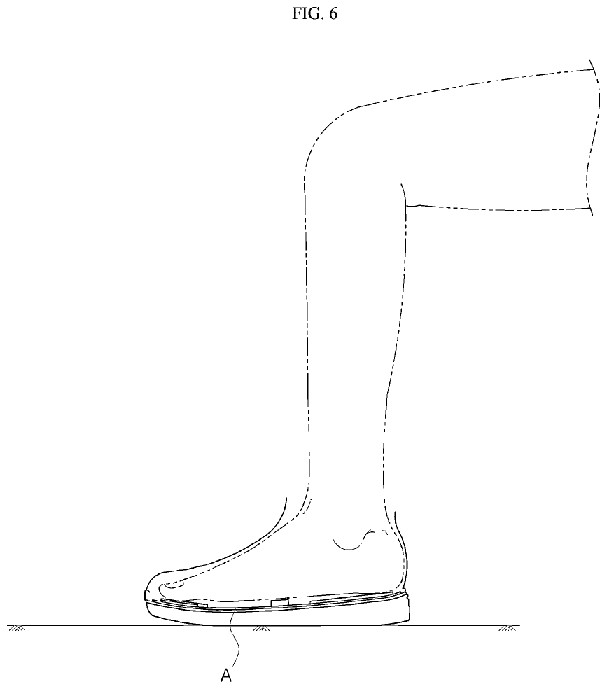

Hereinafter, a foot support structure according to the present disclosure will be described in detail with reference to FIGS. 1 to 13.

As illustrated in FIGS. 1 to 13, the foot support structure A according to the present disclosure includes a base plate 100, a big toe support portion 200, a second and third toe support portion 300, a heel support portion 400, and a Yongcheon acupoint stimulator 500.

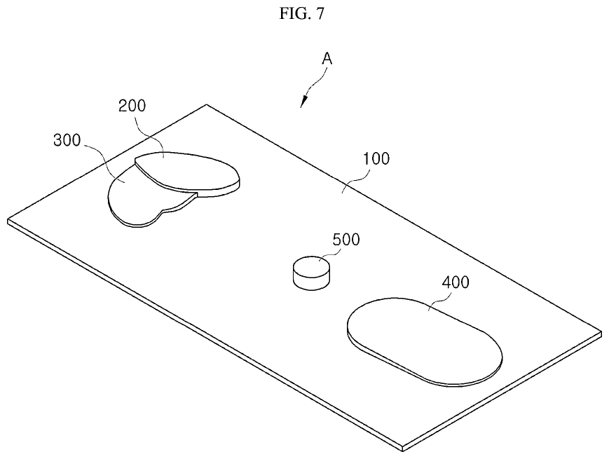

The base plate 100 has a plate shape, and is placed under the foot to support the foot. The base plate 100 may be made of a flexible material, but is not limited thereto, and may also be made of a rigid material. In addition, the base plate 100 may have a plate shape such as a shoe insole as illustrated in FIGS. 1 to 6, but is not limited thereto, and may also have a circular or polygonal plate shape as illustrated in FIGS. 7 to 13. As an example, the base plate 100 may be configured as a shoe insole or a footrest.

Like the base plate 100, the big toe support portion 200, the second and third toe support portion 300, the heel support portion 400, and the Yongcheon acupoint stimulator 500 may be made of a flexible material, but are not limited thereto, and may also be made of a rigid material. The material of the big toe support portion 200, the second and third toe support portion 300, the heel support portion 400, and the Yongcheon acupoint stimulator 500 may be selected in consideration of the material of the base plate 100 and what kind of product (footrest, shoe insole, etc.) the base plate 100 will be used for, but does not necessarily have to be selected in consideration of the base plate 100.

As illustrated shown in FIGS. 1, 3, and 7 to 10, the big toe support portion 200 has a plate shape and protrudes from the base plate 100 at a position where the big toe is placed. As an example, the big toe support portion 200 may be formed in an oval or leaf shape so that the entire bottom of the big toe is supported, and may be provided on a first side of an imaginary center line 10 formed along the longitudinal direction of the base plate 100 and serving as a reference line when the big toe support portion 200, the second and third toe support portion 300, the heel support portion 400, and the Yongcheon acupoint stimulator 500 are provided on the base plate 100. Here, the big toe support portion 200 may be provided so that a longitudinal center line thereof is inclined by about 30° to 45° with respect to the imaginary center line 10. A rear end of the big toe support portion 200 is located at a boundary between the phalanx of the big toe and the metatarsal bone.

The big toe is the part where the difference in support power is the largest among the toes when the user is sitting, compared to when the user is standing. Considering this, as illustrated in FIGS. 1, 3, 7, 9, and 10, it is preferable that the big toe support portion 200 protrudes higher than the second and third toe support portion 300. In addition, since the big toe support portion 200 protrudes higher than the second and third toe support portion 300, a step is formed at a boundary with the second and third toe support portion 300. This is to ensure that the big toe is provided with a significantly more support power than the second toe and the third toe when the user is sitting in consideration of the fact that a lot of force is applied to the big toe compared to the second toe and the third toe when the user is standing.

The second and third toe support portion 300 has a plate shape and protrudes from the base plate 100 at a position where the second toe and the third toe are placed. As an example, as illustrated in FIGS. 1, 2, 7, and 8, the second and third toe support portion 300 may have a front end having an arc shape convex forward from a front end of the big toe support portion 200 toward a second side direction and a rear end having a double top shape convex rearward to correspond to a boundary between the phalanges of the second and third toes and the metatarsal bones so that the entire bottoms of the second and thirds toes are supported. The second and third toe support portion 300 is provided so that most of the area thereof is located on a second side of the imaginary center line 10.

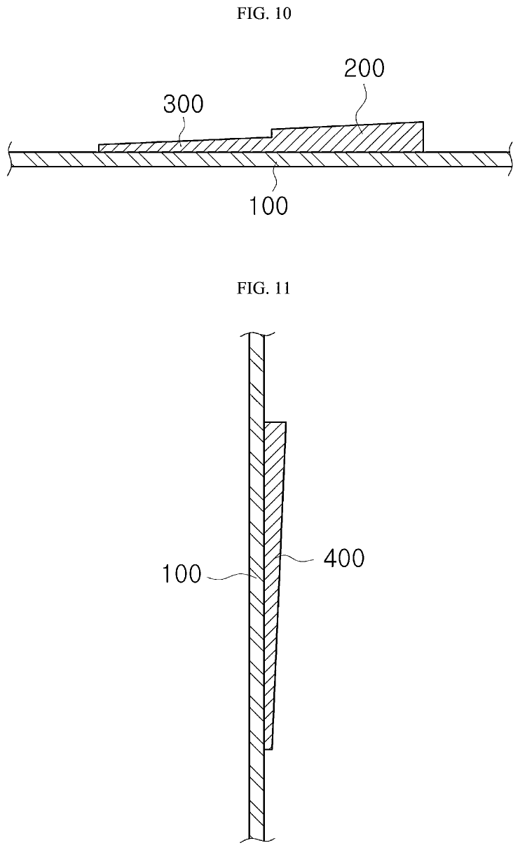

In addition, as illustrated in FIGS. 7 and 10, the big toe support portion 200 and/or the second and third toe support portion 300 is formed to be inclined downward toward the second side direction. This is in consideration of the fact that force applied to the user's foot when the user is standing is weakened from the first side (the side where the big toe is located) to the second side (the side where the little toe is located).

As illustrated in FIGS. 1, 3, and 7 to 9, the heel support portion 400 has a plate shape and protrudes from the base plate 100 at a position where the heel is placed. As an example, the heel support portion 400 may be formed in a rectangle or oval shape whose length is longer than its width so that the entire bottom of the heel is supported. Although the heel is a part where a lot of force is applied together with the big toe when the user is standing, since force is applied to a certain extent even when the user is sitting, it is preferable that the heel support portion protrudes to a maximum height equal to that of the second and third toe support portion 300.

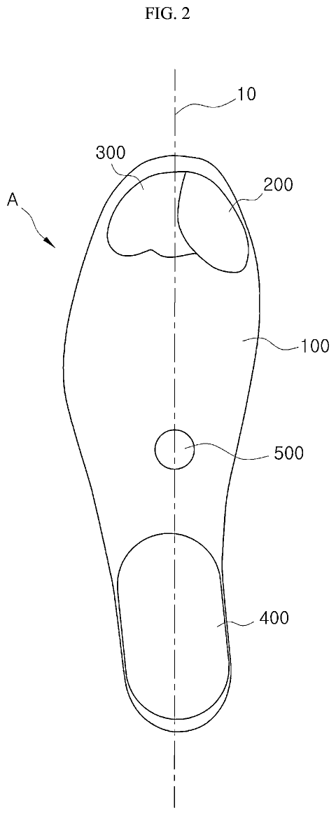

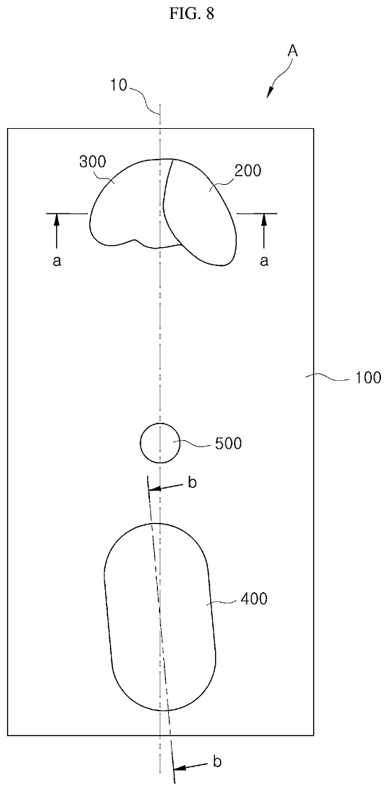

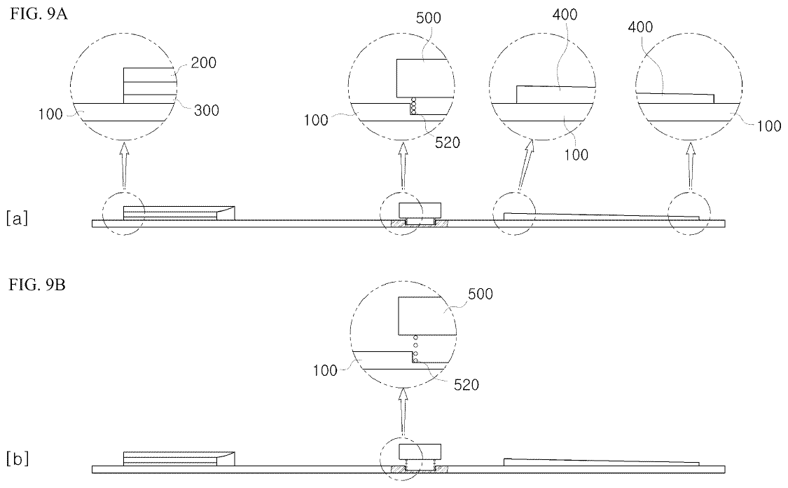

In addition, the entire heel support portion 400 may be formed to have a uniform height, but is not limited thereto, and as illustrated in FIGS. 9 and 11, may be formed to be inclined downward from a front end toward a rear end thereof. The configuration of the heel support portion 400 inclined downward from the front end toward the rear end thereof takes into consideration that force applied to the rear end of the heel is weaker than the front end of the heel when the user is standing. In addition, when the user is standing upright with the toes facing forward, the heel is slightly twisted from the front. Therefore, as illustrated in FIGS. 2 and 8, the heel support portion 400 is preferably provided so that a longitudinal center line thereof is distorted by a predetermined angle from the imaginary center line 10. Here, the predetermined angle means an angle of 5° to 15° with respect to the imaginary center line 10.

As illustrated in FIGS. 1, 3, 7, and 9, the Yongcheon acupoint stimulator 500 protrudes from the base plate 100 at a position corresponding to the Yongcheon acupoint. As an example, the Yongcheon acupoint stimulator 500 may be formed in a plate shape having a predetermined thickness and having a circular or polygonal cross-section, and may have a diameter of about 1.5 cm to 2.5 cm. The Yongcheon acupoint stimulator 500 may be provided to have the same height as the maximum height of the big toe support portion 200, but it is preferably provided higher than the big toe support portion 200 so that the Yongcheon acupoint is stimulated more effectively.

In addition, when the base plate 100 is made of a flexible material, as illustrated in FIG. a first spring 510 exerting an upward elastic force is provided on a bottom surface of the base plate 100 at a position corresponding to the Yongcheon acupoint stimulator 500. This is to stimulate the Yongcheon acupoint with a constant intensity through the first spring 510 in consideration of the fact that the intensity of the Yongcheon acupoint stimulator 500 stimulating the Yongcheon acupoint varies according to the type of shoe in which the base plate 100 is provided and the posture taken by the user.

In addition, as illustrated in FIG. 9, the Yongcheon acupoint stimulator 500 is provided on top of a second spring 520 supported by the base plate 100. Due to an upward elastic force of the second spring 520, the Yongcheon acupoint stimulator 500 elastically presses the Yongcheon acupoint. Therefore, even when the user moves the toes or changes the direction in which force is applied to the sole of the foot in a sitting state, the Yongcheon acupoint stimulator 500 effectively stimulates the Yongcheon acupoint. With the Yongcheon acupoint stimulator 500 for elastic pressing of the Yongcheon acupoint, the Yongcheon acupoint is stimulated not only when the user uses the present disclosure barefoot, but also when the user uses the present disclosure while wearing shoes such as sneakers or dress shoes.

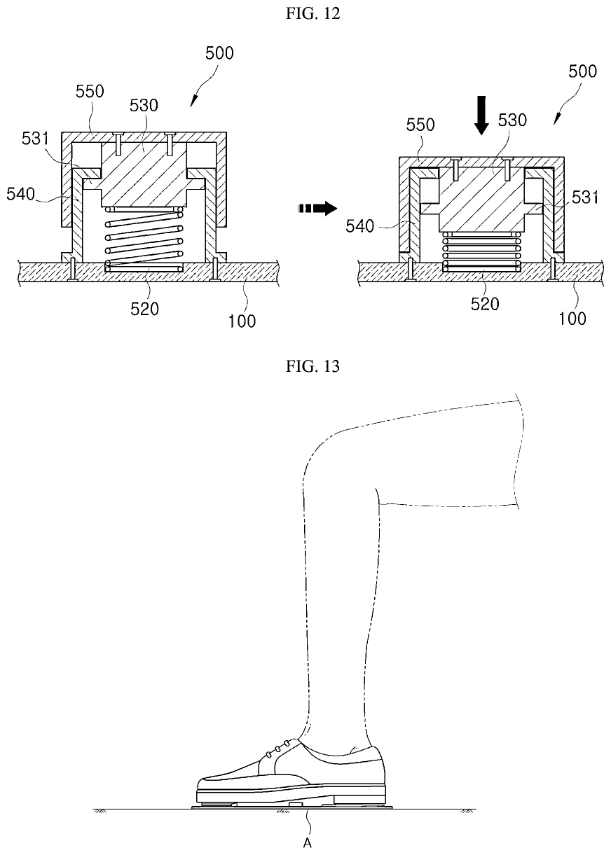

As a specific example, as illustrated in FIG. 12, the Yongcheon acupoint stimulator 500 may include a second spring 520, a moving member 530, a guide member 540, and a stimulation cap 550. The second spring 520 is provided on a top surface of the base plate 100. The moving member 530 has a cylindrical shape and is provided on top of the second spring 520.

Here, a locking protrusion 531 protruding laterally is formed on each side of an outer circumferential surface of the moving member 530. The guide member 540 has a hollow cylindrical shape and has the second spring 520 and the moving member 530 therein. The guide member 540 has a top surface provided with a through-hole through which a part of the moving member 530 protrudes upward, and has a bottom end fixed to the base plate 100. The through hole is formed with a diameter equal to or slightly larger than that of the moving member 530. The respective protrusions 531 are caught on the edge of the top surface of the guide member 540 where the through-hole is formed, thereby limiting upward movement of the moving member 530 elastically moved upward by the second spring 520.

The stimulation cap 550 is formed in a “C” shape in longitudinal section, and is coupled to a top end of the moving member 530 to surround the guide member 540. Therefore, the stimulation cap 550 is moved up and down in conjunction with the movement of the moving member 530. In particular, when the stimulation cap 550 is moved downward, a bottom end thereof comes into contact with the bottom end of the base plate 100 or the guide tool 540, thereby limiting downward movement. With the Yongcheon acupoint stimulator 500 configured as described above, the height at which a top surface of the Yongcheon acupoint stimulator 500 is separated from the base plate 100 when the second spring 520 is compressed is set, and the height at which the top surface of the Yongcheon acupoint stimulator 500 is separated from the base plate 100 when the second spring 520 is relaxed is set.

As an embodiment of the foot support structure A according to the present disclosure, as illustrated in FIGS. 1 to 6, when the base plate 100 is configured as a flexible shoe insole, the big toe support portion 200 may have a thickness of 4 mm, the second and third toe support portion 300 may have a thickness of 2 mm, the heel support portion 400 may have a thickness of 2 mm, and the Yongcheon acupoint stimulator 500 may have a thickness of 6 mm. In addition, as another embodiment of the foot support structure A according to the present disclosure, as illustrated in FIGS. 7 to 13, when the base plate 100 is configured as a solid footrest, the big toe support portion 200 may have a maximum thickness of 10 mm, the second and third toe support portion 300 may have a maximum thickness of 6 mm, the heel support portion 400 may have a maximum thickness of 6 mm, and Yongcheon acupoint stimulator 500 may have a maximum thickness of 12 mm to 16 mm. In this case, when the Yongcheon acupoint stimulator 500 is elastically pressed by the second spring 520, the top surface of the Yongcheon acupoint stimulator 500 is positioned spaced apart by about 12 mm from the base plate 100 in a compressed state of the second spring 520, and the top surface of the Yongcheon acupoint stimulator 500 is positioned spaced apart by about 16 mm in a relaxed state of the second spring 520.

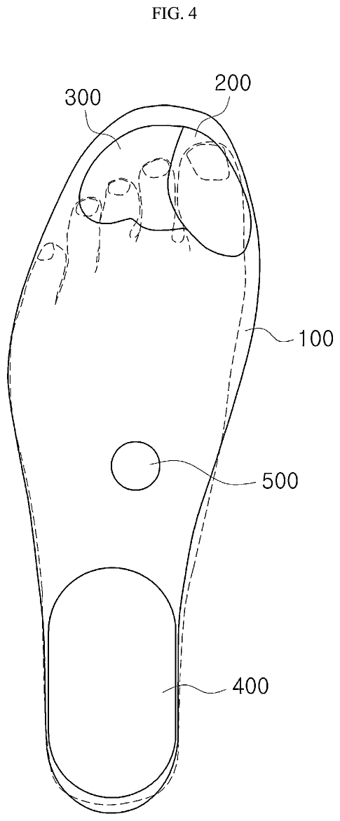

As illustrated in FIGS. 7 and 13, when the present disclosure is used while the user is sitting, as illustrated in FIG. 4, the big toe is supported by the big toe support portion 200, the second toe and the third toe are supported by the second and third toe support portion 300, and the heel is supported by the heel support portion 400, so that the Yongcheon acupoint is pressed by the Yongcheon acupoint stimulator 500 in a state in which a part of the sole of the foot to which force is applied when the user is standing is supported. Therefore, the Yongcheon acupoint is effectively stimulated even when the user is sitting, thereby increasing the regional cerebral blood flow and facilitating breathing. By using the present disclosure even when the user is sitting in an office or a car, it is possible to prevent drowsiness through the increase in the regional cerebral blood flow. In particular, an effect can be obtained when the user uses the present disclosure on one foot, such as the left foot or the right foot, in a sitting state.

### DESCRIPTION OF THE REFERENCE NUMERALS IN THE DRAWINGS

A: foot support structure
10: imaginary center line
100: base plate
200: big toe support portion
300: second and third toe support portion
400: heel support portion
500: Yongcheon acupoint stimulator
510: first spring
520: second spring
530: moving member
531: locking protrusion
540: guide member
550: stimulation cap

1. A foot support structure comprising:
a base plate (100) configured to be placed under the foot and to support the foot;
a big toe support portion (200) formed in a plate shape and protruding from the base plate (100) configured at a position to support the big toe;
a second and third toe support portion (300) formed in a plate shape and protruding from the base plate (100) configured at a position to support the second toe and the third toe;
a heel support portion (400) formed in a plate shape and protruding from the base plate (100) configured at a position to support the heel; and
a Yongcheon acupoint stimulator (500) protruding from the base plate (100) at a position corresponding to the Yongcheon acupoint.

2. The foot support structure of claim 1, wherein the big toe support portion (200) protrudes higher than the second and third toe support portion (300), and a step is formed at a boundary between the big toe support portion (200) and the second and third toe support portion (300).

3. The foot support structure of claim 2, wherein the Yongcheon acupoint stimulator (500) is provided higher than the big toe support portion (200), and the heel support portion (400) protrudes to a maximum height equal to that of the second and third toe support portion (300).

4. The foot support structure of claim 1, wherein the Yongcheon acupoint stimulator (500) is provided on top of a second spring (520) supported by the base plate (100), and elastically presses the Yongcheon acupoint through the second spring (520).

5. The foot support structure of claim 1, wherein the heel support portion (400) is provided so that a longitudinal center line thereof is distorted by a predetermined angle from an imaginary center line (10) formed along a longitudinal direction of the base plate (100) through a center of the Yongcheon acupoint stimulator (500).
